(19) United States
(12) Patent Application Publication
(10) Pub. No.: US 2023/0163304 A1
(43) Pub. Date: May 25, 2023

(54) CATHODE MATERIAL OF AQUEOUS ZINC-ION BATTERY AND AQUEOUS ZINC-ION BATTERY

(71) Applicant: NATIONAL CHENG KUNG UNIVERSITY, Tainan (TW)

(72) Inventors: Watchareeya KAVEEVIVITCHAI, Tainan (TW); Nhu Thi Huynh LUU, Tainan (TW); Teng-Hao CHEN, Tainan (TW)

(73) Assignee: NATIONAL CHENG KUNG UNIVERSITY, Tainan (TW)

(21) Appl. No.: 17/661,888

(22) Filed: May 3, 2022

(30) Foreign Application Priority Data
Nov. 22, 2021 (TW) 110143424

(51) Int. Cl. H01M 4/60; H01M 10/26; H01M 4/134; H01M 4/62

(52) U.S. Cl. CPC H01M 4/60; H01M 10/26; H01M 4/134; H01M 4/623; H01M 4/625; H01M 2004/027

(57) ABSTRACT

A cathode material of an aqueous zinc-ion battery and an aqueous zinc-ion battery are described. The aqueous zinc-ion battery has a cathode material of the aqueous zinc-ion battery of the embodiment of the present disclosure, which has a specific ratio of specific cathode material. At a specific current density (50 mA/g), an electrochemical capacity of the aqueous zinc-ion battery can reach about 500 mAh/g, and a capacity can reach 200 mAh/g at a current density of 20 A/g.

### CROSS REFERENCE TO RELATED APPLICATION

This application claims priority to Taiwan Patent Application No. 110143424, filed on Nov. 22, 2021, which is incorporated herein by reference in its entirety.

### FIELD OF DISCLOSURE

The present disclosure relates to batteries, and more particularly to a cathode material of an aqueous zinc-ion battery and an aqueous zinc-ion battery.

### BACKGROUND OF DISCLOSURE

In recent years, lithium-ion batteries have been widely used in various electronic products, electric vehicles, or energy storage devices. However, the existing lithium-ion batteries have encountered technical bottlenecks and challenges in further electrochemical advancement. In addition, there are still doubts about safety of lithium-ion batteries.

In another aspect, compared with lithium metal, zinc has high natural abundance and is inexpensive, non-toxic, and compatible with water-based electrolytes. Divalent zinc ions can provide higher theoretical gravimetric and volumetric capacities. Aqueous zinc-ion batteries do not need to be assembled in an inert environment and do not use organic solvents. Therefore, there is no safety risk similar to lithium-ion batteries, so some companies have begun to study aqueous zinc-ion batteries. However, an electrochemical capacity and charge-discharge rate of the existing aqueous zinc-ion battery are still not satisfactory. Therefore, both the electrochemical capacity and the charge-discharge rate need to be improved.

Therefore, it is necessary to provide a cathode material of an aqueous zinc-ion battery and an aqueous zinc-ion battery to solve problems of conventional technologies.

### SUMMARY OF DISCLOSURE

An object of the present disclosure is to provide a cathode material of an aqueous zinc-ion battery, which has multiple redox-active sites and is insoluble in aqueous electrolyte. The cathode material of the aqueous zinc-ion battery uses small organic molecules as electrode materials to have advantages of structural tunability, environmental friendliness, recyclability, and low cost.

Another further object of the present disclosure is to provide an aqueous zinc-ion battery comprising the cathode material of the aqueous zinc-ion battery according to an embodiment of the present disclosure. It has a specific ratio of specific cathode materials, which has a capacity of about 500 mAh/g at a specific current density (50 mA/g), and has a capacity of about 200 mAh/g at a current density of 20 A/g.

To achieve the above object, the present disclosure provides a cathode material of an aqueous zinc-ion battery, comprising at least one compound with following formula (1) of:

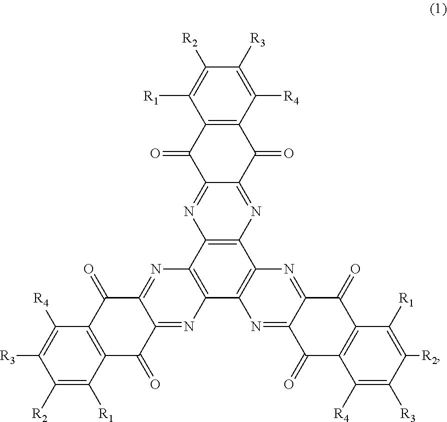

wherein each of R₁ to R₄ is selected from a group consisting of hydrogen, hydrocarbon, halogen, alkoxy, arylamine, ester, amide, aromatic hydrocarbon, heterocyclic compound, nitro, and nitrile (—CN) group.

In an embodiment of the present disclosure, at least one of R₁ to R₄ has hydrogen.

In an embodiment of the present disclosure, each of R₁ to R₄ is hydrogen.

In an embodiment of the present disclosure, at least one compound comprises a plurality of compound molecules with formula (1), wherein at least one intermolecular hydrogen bond is formed between the plurality of compound molecules.

To achieve the above object, the present disclosure provides an aqueous zinc-ion battery, comprising a cathode material of an aqueous zinc-ion battery according to any one embodiment described above.

In an embodiment of the present disclosure, the aqueous zinc-ion battery further comprises an anode material; and an electrolyte. The electrolyte is arranged between the cathode material and the anode material.

In an embodiment of the present disclosure, the anode material comprises zinc metal.

In an embodiment of the present disclosure, the electrolyte includes a zinc salt, and the zinc salt includes at least one of ZnSO₄, Zn(CF₃SO₃)₂, and Zn(NO₃)₂.

In an embodiment of the present disclosure, the aqueous zinc-ion battery further comprises: conducting additive and polyvinylidene fluoride, wherein the conducting additive, polyvinylidene fluoride and the cathode material are mixed to form a mixture, wherein a total weight of the mixture is 100 wt %, and the mixture includes 30 to 70 wt % of the cathode material, 20 to 60 wt % of the conducting additive, and 5 to 15 wt % of the polyvinylidene fluoride.

In an embodiment of the present disclosure, the mixture includes 30 to 35 wt % of the cathode material, 55 to 60 wt % of the conducting additive, and 5 to 15 wt % of the polyvinylidene fluoride.

### DESCRIPTION OF DRAWINGS

FIG. 1 is a schematic flowchart of a method of fabricating a cathode material of an aqueous zinc-ion battery according to an embodiment of the present disclosure.

FIG. 2 is a schematic diagram of a graphite-like layered structure formed by a cathode material of an aqueous zinc-ion battery according to an embodiment of the present disclosure.

FIG. 3 is a cross-sectional view of a cathode material of an aqueous zinc-ion battery according to an embodiment of the present disclosure.

FIG. 4A and FIG. 4B are diagrams of a voltage profile and a capacity retention analysis of HATAQ at current densities of 50 mA/g to 500 mA/g.

FIG. 4C is a diagram of a capacity retention analysis of HATAQ at current densities of 2 A/g to 20 A/g.

FIG. 4D is an analysis diagram of HATAQ rate performance.

FIG. 5A and FIG. 5B are diagrams of a voltage profile and a capacity retention analysis of HATAQ of Embodiments 1 to 3 at a current density of 200 mA/g.

FIG. 6 is a diagram of a capacity retention analysis of HATAQ of Embodiments 1, 4, and 5 at a current density of 200 mA/g.

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, and etc., are only directions by referring to the accompanying drawings, and thus the used directional terms are used to describe and understand the present disclosure, but the present disclosure is not limited thereto.

An embodiment of the present disclosure provides a cathode material of an aqueous zinc-ion battery, comprising a compound with following formula (1) of:

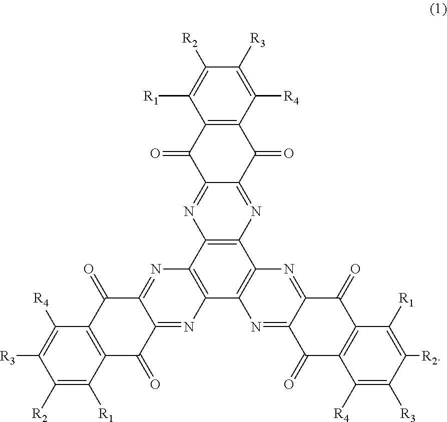

It is noted that, each of R₁ to R₄ in the formula (1) is selected from a group consisting of hydrogen, hydrocarbon, halogen, alkoxy, arylamine, ester, amide, aromatic hydrocarbon, heterocyclic compound, nitro, and nitrile group.

In an embodiment, at least one of R₁ to R₄ has hydrogen, which can form at least one hydrogen bond between molecules of compound (C—H . . . O bonds). In another embodiment, each of R₁ to R₄ is hydrogen, which can form at least one hydrogen bond between molecules of compound (C—H . . . O bonds).

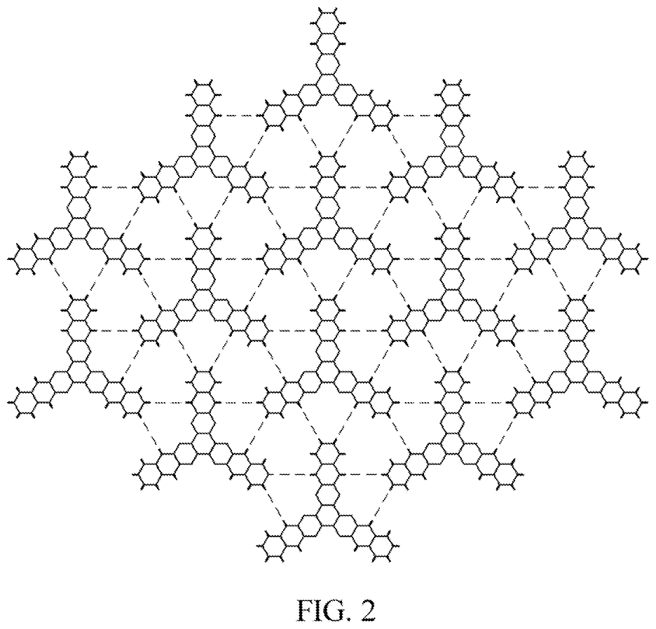

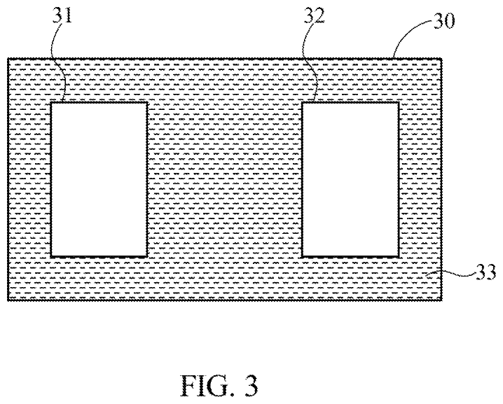

It is further illustrated that when each of R₁ to R₄ in formula (1) is hydrogen, intermolecular hydrogen bonds can be formed between a plurality of compound molecules with formula (1). As shown in FIG. 2, each of the plurality of compound molecules can form intermolecular hydrogen bonds with oxygen (e.g., oxygen adjacent to R₁ or R₄) of another of the plurality of compound molecules through the hydrogen located at the R₂ or R₃ position (referring to formula (1)). However, it should be mentioned that the R₁ or R₄ may also form an intermolecular hydrogen bond with oxygen of another compound molecule (e.g., oxygen adjacent to R₁ or R₄). In other words, each hydrogen at R₁, R₂, R₃, and R₄ has an opportunity to form intermolecular hydrogen bonds with the oxygen of another compound molecule.

Specifically, by designing and synthesizing electron-accepting hexaazatriphenylene (HAT) embedded quinone (HATAQ) and/or its derivative small molecules (e.g., formula (1)), it can form intermolecular hydrogen bonds, so as to form a graphite-like layered structure. Therefore, when HATAQ and/or its derivative small molecules are used as a cathode material, a stable structure can be maintained during a charge and discharge process and during charge carriers (such as zinc ions, H⁺ ions, and/or other ions) entering and exiting. Therefore, using HATAQ and/or its derivative small molecules as a cathode material can exhibit excellent charge and discharge rate capability results. For example, when a current density is 50 mA/g, the cathode material has a capacity of about 500 mAh/g; when an ultra-high current density is 20000 mA/g, the cathode material has a reversible capacity of about 200 mAh/g after 1000 cycles of charge and discharge, and maintains almost no loss of capacity (i.e., maintains about 100% of the capacity).

In addition, it should be mentioned that, for one skilled in the art, components of different types of batteries in different fields cannot be directly exchanged, and the effects of exchange cannot be expected. For example, the mechanism of lithium-ion batteries and aqueous zinc-ion batteries is not the same. Therefore, when any of the battery materials of lithium-ion batteries (such as cathode material, anode material, electrolyte, etc.) are directly transferred to any of the battery materials of the aqueous zinc-ion battery, one skilled in the art will not be able to predict what effect will be produced. In one embodiment, the cathode material of the aqueous zinc-ion battery of the present disclosure is used, and the battery can maintain a capacity of about 100% at an ultra-high current density of 20,000 mA/g and after a high number of charge and discharge cycles. This effect cannot be expected. It is also worth mentioning that the present disclosure is directed to aqueous zinc-ion batteries. Therefore, it does not contain organic solvents, so it is relatively safe.

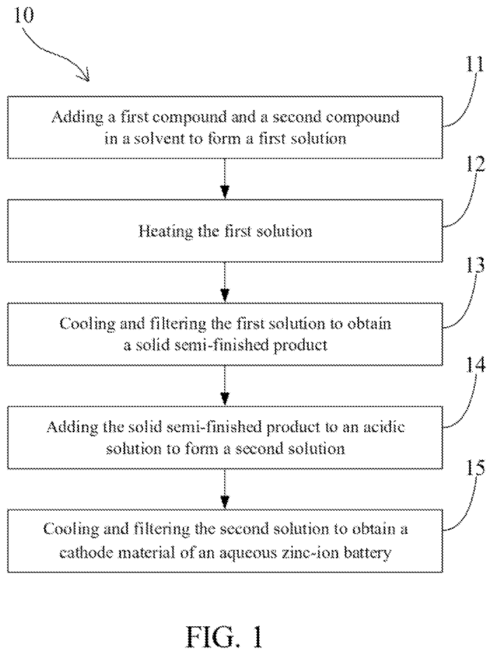

Referring to FIG. 1, an embodiment of the present disclosure provides a method 10 of fabricating a cathode material of an aqueous zinc-ion battery, which mainly comprises following steps 11 to 15 of:
(step 11): adding a first compound and a second compound in a solvent to form a first solution, wherein a molar ratio of the first compound and the second compound is between 2 and 5, and the first compound and the second compound are respectively represented by following formula (2) and formula (3):

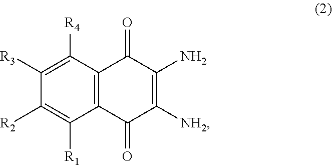

wherein each of R₁ to R₄ is selected from a group consisting of hydrogen, hydrocarbon, halogen, alkoxy, arylamine, ester, amide, aromatic hydrocarbon, heterocyclic compound, nitro, and nitrile group; and

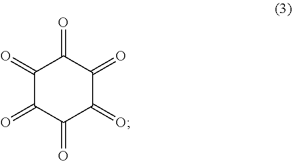 [SMILES: O=C1C(=O)C(=O)C(=O)C(=O)C1=O]

(step 12): heating the first solution at 100 to 140° C. for 18 to 30 hours under a protective gas environment;
(step 13): cooling and filtering the first solution to obtain a solid semi-finished product;
(step 14): adding the solid semi-finished product to an acidic solution to form a suspension, and heating the suspension at 90 to 110° C. for 1 to 3 hours; and
(step 15): cooling and filtering the suspension to obtain the cathode material of the aqueous zinc-ion battery, wherein the cathode material of the aqueous zinc-ion battery comprises at least one compound with following formula (1) of:

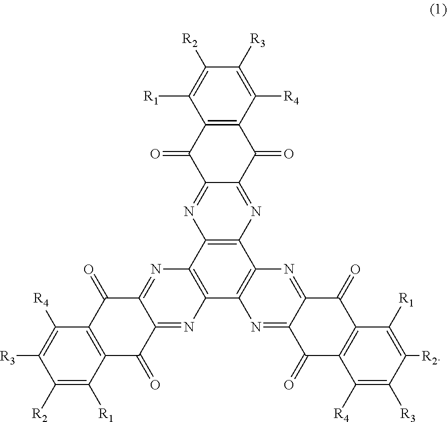

In the present disclosure, the implementation details and principles of the above-mentioned steps of the embodiments are described in detail below in sequence.

At first, the method 10 of fabricating a cathode material for an aqueous zinc-ion battery according to an embodiment of the present disclosure has a step 11 of: adding a first compound and a second compound in a solvent to form a first solution, wherein a molar ratio of the first compound and the second compound is between 2 and 5, and the first compound and the second compound are respectively represented by the above formula (2) and formula (3). In step 11, the first compound can be referred to as 2,3-diamino-1,4-naphtoquinone (i.e., both X, Y are C; and R₁ to R₄ are H) and/or its derivatives. Further, the second compound can be referred to as cyclohexane hexaketone, which is generally present in the form of eight water molecules (cyclohexane hexaketone octahydrate). In an embodiment, at least one of R₁ to R₄ in formula (2) has hydrogen, which can form at least one hydrogen bond between molecules of compound (C—H . . . O bonds). In another embodiment, each of R₁ to R₄ in formula (2) is hydrogen, which can form at least one hydrogen bond between molecules of compound (C—H . . . O bonds).

In an embodiment, considering the structural formula of the product (i.e., formula (1)), a molar ratio of the first compound and the second compound can be about 3, but the molar ratio can also be 2.5, 3.5, 4, or 4.5. In the case where the molar ratio is greater than 5 or less than 2, an excessive use of either the first compound or the second compound results in waste of cost. In another embodiment, the solvent may be a solvent that can dissolve the first compound and the second compound, and does not negatively affect the prepared cathode material. In an example, the solvent may be degassed glacial acetic acid. In another example, a molar concentration of the first compound and the solvent is such as between 0.15 and 0.25 M, and a molar concentration of the second compound and the solvent is such as between 0.05 and 0.1 M.

Then, the method 10 of fabricating a cathode material for an aqueous zinc-ion battery according to an embodiment of the present disclosure has a step 12 of: heating the first solution at 100 to 140° C. for 18 to 30 hours under a protective gas environment. In step 12, an appropriate heating temperature is mainly applied to cause the first compound to react with the second compound. In an embodiment, the protective gas may be at least one of nitrogen, helium, neon, and argon. In an example, the step 12 is performed by heating the first solution under reflux at about 120° C. for about 24 hours in an argon atmosphere. In another example, the aforementioned temperature is, for example, 105, 110, 115, 120, 125, 130, or 135° C. In another example, the aforementioned time is, for example, 19, 20, 21, 22, 24, 26, 27, 28, or 29 hours.

Then, the method 10 of fabricating a cathode material for an aqueous zinc-ion battery according to an embodiment of the present disclosure has a step 13 of: cooling and filtering the first solution to obtain a solid semi-finished product. In step 13, a dark brown solid semi-finished product can be obtained by cooling (for example, cooling to about 50 to 70° C., such as about 60° C.) and filtering.

In an embodiment, after the step 13 of cooling and filtering the first solution and before the step 14 of adding the solid semi-finished product to the acidic solution to form the suspension, the method 10 further comprises a step of: washing the solid semi-finished product with glacial acetic acid, ethanol, acetone, and water in sequence, and drying the solid semi-finished product under vacuum for 18 to 30 hours, so as to remove impurities attached onto the solid semi-finished product.

Then, the method 10 of fabricating a cathode material for an aqueous zinc-ion battery according to an embodiment of the present disclosure has a step 14 of: adding the solid semi-finished product to an acidic solution to form a suspension, and heating the suspension at 90 to 110° C. for 1 to 3 hours. In step 14, for example, the obtained solid semi-finished product is added to 25% nitric acid (HNO₃) to form a suspension with the solid semi-finished product (i.e., the suspension). The obtained suspension is heated under reflux with vigorous stirring at about 100° C. for about 2 hours. After the reaction, the suspension with the solid semi-finished product changed from dark brown to dark orange.

Then, the method 10 of fabricating a cathode material for an aqueous zinc-ion battery according to an embodiment of the present disclosure has a step 15 of: cooling and filtering the suspension to obtain the cathode material of the aqueous zinc-ion battery, wherein the cathode material of the aqueous zinc-ion battery comprises at least one compound with the above formula (1). In step 15, the orange-yellow cathode material of the aqueous zinc-ion battery can be obtained by cooling (for example, cooling to room temperature, such as about 25° C.) and filtering through a filter (for example, a glass filter). In one embodiment, the cathode material of the aqueous zinc-ion battery can be washed with deionized water, and the cathode material of the aqueous zinc-ion battery can be dried under vacuum for 6 to 12 hours. In one example, the cathode material of the aqueous zinc-ion battery can be washed repeatedly (for example, 3 to 7 times) with deionized water and the cathode material of the aqueous zinc-ion battery can be dried under vacuum for about 8 hours (for example, overnight), so as to obtain the cathode material of the aqueous zinc-ion battery.

It can be seen from the above that the fabricating method 10 of an embodiment of the present disclosure can be used to prepare the cathode material (i.e., formula (1)) of an aqueous zinc-ion battery as described above in any embodiment of the present disclosure. Further, the cathode material of the aqueous zinc-ion battery prepared by the fabricating method 10 of any one embodiment of the present disclosure can have a same effect as the cathode material of the aqueous zinc-ion battery of any one embodiment of the present disclosure, so it will not be repeated.

It should be mentioned that the cathode material (HATAQ) of the aqueous zinc-ion battery of the present disclosure is different from other hexaazatriphenylene (HAT) derivatives at least in that: the general HAT (or its derivatives) does not have a quinone structure, nor can it use the C—H bond (or hydrogen at any position of R₁-R₄) on the benzene ring to form an intermolecular hydrogen bond with the C═O bond.

In addition, it should be mentioned that the present disclosure also provides an aqueous zinc-ion battery 30, which includes the cathode material 31 of the aqueous zinc-ion battery as described in any one of the above embodiments. In one embodiment, the present disclosure excludes the application of the positive electrode material to other components of the aqueous zinc-ion battery, such as anode material, electrolyte, or separator. In another embodiment, a known cathode material in conventional lithium battery can be replaced with the cathode material according to any one embodiment of the present disclosure, which can improve an original capacity and charge and discharge rate capability.

In an embodiment, the aqueous zinc-ion battery 30 further comprises an anode material 32; and an electrolyte 33 arranged between the cathode material 31 and the anode material 32. In an example, the anode material 32 comprises zinc metal. In another example, the electrolyte 33 includes a zinc salt, and the zinc salt includes at least one of ZnSO₄, Zn(CF₃SO₃)₂, and Zn(NO₃)₂.

In an embodiment, the aqueous zinc-ion battery 30 further comprises conducting additive and polyvinylidene fluoride, wherein the conducting additive, polyvinylidene fluoride and the cathode material are mixed to form a mixture, wherein a total weight of the mixture is 100 wt %, and the mixture includes 30 to 70 wt % of the cathode material, 20 to 60 wt % of the conducting additive, and 5 to 15 wt % of the polyvinylidene fluoride. In an example, the mixture includes 30 to 35 wt % of the cathode material, 55 to 60 wt % of the conducting additive, and 5 to 15 wt % of the polyvinylidene fluoride. In an example, the conducting additive can include conductive carbon black.

It is noted that, in an embodiment of the present disclosure, an aqueous zinc-ion battery comprises the cathode material of the aqueous zinc-ion battery according to an embodiment of the present disclosure. It has a specific ratio of specific cathode materials, which has a capacity of about 500 mAh/g at a specific current density (50 mA/g), and has a capacity of about 200 mAh/g at a current density of 20 A/g.

The following provides specific experimental data analysis to illustrate that the cathode material of the aqueous zinc-ion battery of an embodiment of the present disclosure have the above-mentioned effects.

### Embodiment 1

2,3-Diamino-1,4-naphtoquinone (61.2 g, 325 mmol) and cyclohexane hexaketone octahydrate (31.2 g, 100 mmol) are dissolved in the degassed glacial acetic acid (1500 mL) to form a first solution. Then, the first solution is heated under reflux at about 120° C. for about 24 hours under a protective gas environment (for example, under an argon atmosphere). After the reaction is completed, the reactive mixture is cooled to about 60° C., and the solid semi-finished product is recovered by filtration. The obtained solid semi-finished product is washed sequentially with glacial acetic acid (for example, about 200 mL), ethanol (for example, about 200 mL), acetone (for example, about 200 mL), and water (for example, about 200 mL), and dried under vacuum for about 24 hours. The obtained solid semi-finished product is added and suspended in an acidic solution (for example, 25% nitric acid, for example, about 250 mL). The resulting suspension is heated under reflux with vigorous stirring at about 100° C. for about 2 hours. After heating, a color of the suspension changed from dark brown to dark orange. Then, the reactive mixture is cooled to room temperature, and the solid (i.e., the cathode material of the aqueous zinc-ion battery) is separated by a glass filter. The cathode material of the aqueous zinc-ion battery is washed with deionized water (5×500 mL) and then dried under vacuum overnight (about 8 hours). The obtained cathode material (HATAQ) of the aqueous zinc-ion battery is an orange powder (about 54.3 g, about 87% yield).

Then, HATAQ is ground and mixed with conducting additive (such as Ketjen black conductive carbon (Lion Specialty Chemicals Company; Japan)) and polyvinylidene fluoride (PVDF) in a weight ratio of about 3:6:1 to form a mixture. Then, the mixture is stirred in N-methylpyrrolidone (NMP) and coated onto carbon paper used as a current collector, so as to serve as a cathode. The cathode is vacuum dried overnight at about 80° C.

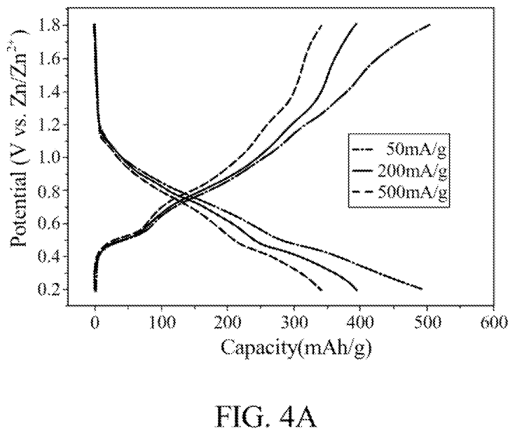

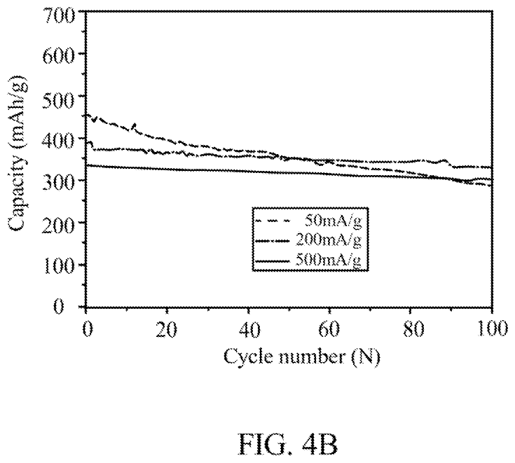

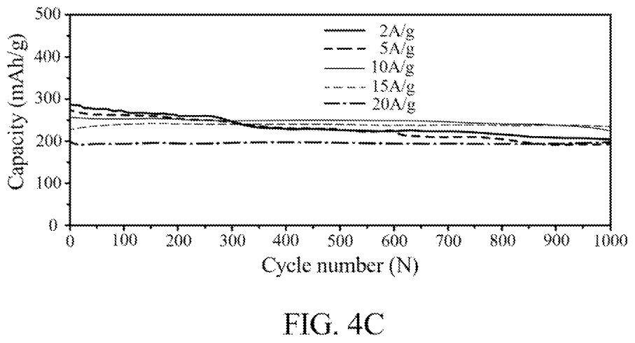

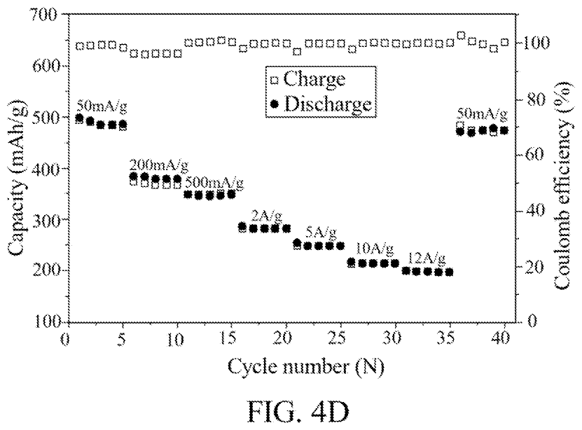

Then, the above cathode is used as a cathode of a CR2032 coin cell, where the CR2032 coin cell are assembled by: using Zn metal as anode; using 1 M ZnSO₄ as an electrolyte; and using a glass fiber filter paper (Whatman Company) as a separator. Then, galvanostatic charge/discharge and cyclic voltammetry measurements are performed with a battery cycler (Neware company) and VMP3 system (BioLogic company). The analysis results are shown in FIG. 4A to FIG. 4D.

FIG. 4A to FIG. 4D relate to electrochemical properties of HATAQ. FIG. 4A and FIG. 4B are diagrams of a voltage profile and a capacity retention analysis of HATAQ at current densities of 50 mA/g to 500 mA/g. FIG. 4C is a diagram of a capacity retention analysis of HATAQ at current densities of 2 A/g to 20 A/g. FIG. 4D is an analysis diagram of HATAQ rate performance.

From FIG. 4A to FIG. 4D, it can be seen that using HATAQ and/or its derivative small molecules as a cathode material can exhibit excellent charge and discharge results. For example, when a current density is 50 mA/g, the cathode material has a capacity of about 500 mAh/g; when an ultra-high current density is 20000 mA/g, the cathode material has a reversible capacity of about 200 mAh/g after 1000 cycles of charge and discharge, and maintains about 100% of the capacity.

### Embodiments 2 to 3

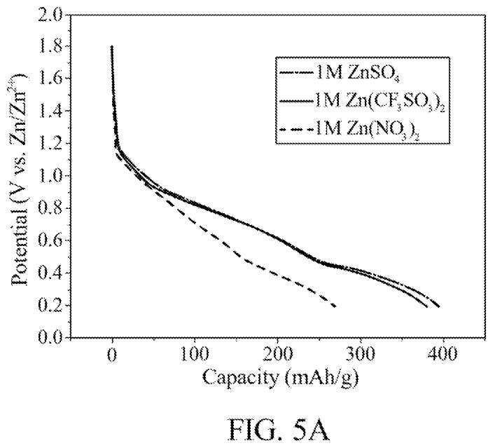

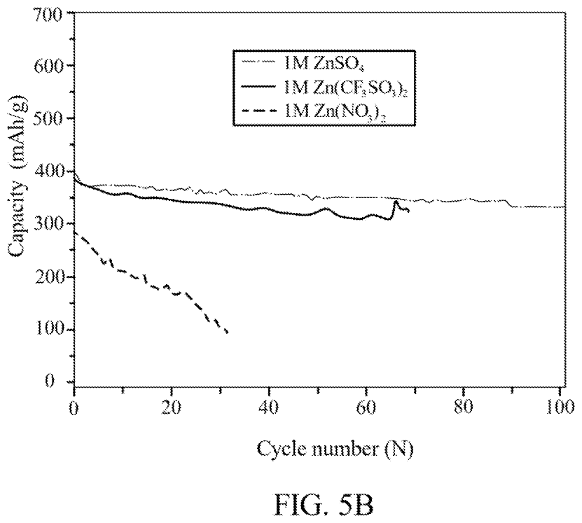

The fabricating methods of Embodiments 2 to 3 are substantially the same as that of Embodiment 1, but the electrolytes used are different (Embodiment 2: Zn(CF₃SO₃)₂; Embodiment 3: Zn(NO₃)₂), and the analysis results are shown in FIG. 5A and FIG. 5B. FIG. 5A and FIG. 5B are diagrams of a voltage profile and a capacity retention analysis of HATAQ of Embodiments 1 to 3 at a current density of 200 mA/g. It can be seen from FIG. 5A and FIG. 5B that an initial capacity of Embodiment 1 is about 394 mAh/g; an initial capacity of Embodiment 2 is about 380 mAh/g; and an initial capacity of Embodiment 3 is about 275 mAh/g. In principle, after multiple cycles of charge and discharge, Embodiment 1 is far superior to Embodiments 2 and 3.

### Embodiments 4 and 5

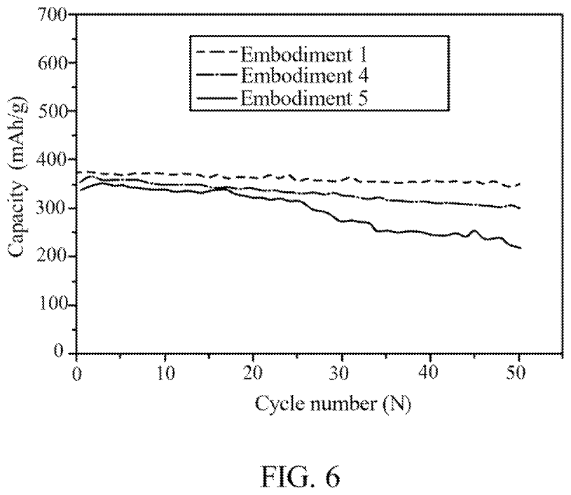

The fabricating methods of Embodiments 4 to 5 are substantially the same as that of Embodiment 1, but a ratio of the cathode material used is different. (Embodiment 4: HATAQ is mixed with conducting additive (such as conductive carbon black (Ketjen black; Japan)) and polyvinylidene fluoride (PVDF) in a weight ratio of about 5:4:1; and Embodiment 5: HATAQ is mixed with conducting additive (such as conductive carbon black (Ketjen black; Japan)) and polyvinylidene fluoride (PVDF) in a weight ratio of about 7:2:1). The analysis results are shown in FIG. 6. FIG. 6 is a diagram of a capacity retention analysis of HATAQ of Embodiments 1, 4, and 5 at a current density of 200 mA/g. It can be seen from FIG. 6 that an initial capacity of Embodiment 1 is about 394 mAh/g; an initial capacity of Embodiment 4 is about 355 mAh/g; and an initial capacity of Embodiment 5 is about 340 mAh/g. In principle, after multiple cycles of charge and discharge, Embodiment 1 is far superior to Embodiments 4 and 5.

The present disclosure has been described with a preferred embodiment thereof and it is understood that many changes and modifications to the described embodiment can be carried out without departing from the scope and the spirit of the disclosure that is intended to be limited only by the appended claims.

1. A cathode material of an aqueous zinc-ion battery, comprising a compound molecule with following formula (1) of: 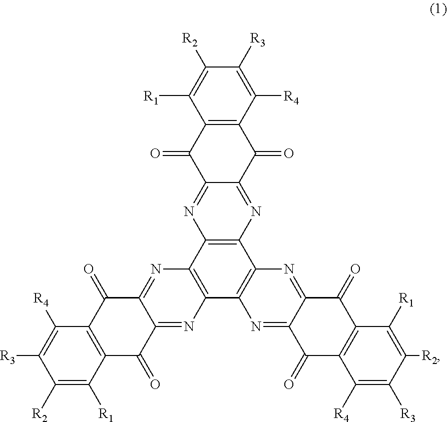
wherein each of R₁ to R₄ is selected from a group consisting of hydrogen, hydrocarbon, halogen, alkoxy, arylamine, ester, amide, aromatic hydrocarbon, heterocyclic compound, nitro, and nitrile group.

2. The cathode material of the aqueous zinc-ion battery according to claim 1, wherein at least one of R₁ to R₄ has hydrogen.

3. The cathode material of the aqueous zinc-ion battery according to claim 1, wherein each of R₁ to R₄ is hydrogen.

4. The cathode material of the aqueous zinc-ion battery according to claim 1, wherein at least one compound comprises a plurality of compound molecules with formula (1), wherein at least one intermolecular hydrogen bond is formed between the plurality of compound molecules.

5. An aqueous zinc-ion battery, comprising a cathode material of the aqueous zinc-ion battery according to claim 1.

6. The aqueous zinc-ion battery according to claim 5, further comprising:
an anode material; and
an electrolyte arranged between the cathode material and the anode material.

7. The aqueous zinc-ion battery according to claim 6, wherein the anode material comprises zinc metal.

8. The aqueous zinc-ion battery according to claim 6, wherein the electrolyte includes a zinc salt, and the zinc salt includes at least one of ZnSO₄, Zn(CF₃SO₃)₂, and Zn(NO₃)₂.

9. The aqueous zinc-ion battery according to claim 6, further comprising: conducting additive and polyvinylidene fluoride, wherein the conducting additive, polyvinylidene fluoride and the cathode material are mixed to form a mixture, wherein a total weight of the mixture is 100 wt %, and the mixture includes 30 to 70 wt % of the cathode material, 20 to 60 wt % of the conducting additive, and 5 to 15 wt % of the polyvinylidene fluoride.

10. The aqueous zinc-ion battery according to claim 9, wherein the mixture includes 30 to 35 wt % of the cathode material, 55 to 60 wt % of the conducting additive, and 5 to 15 wt % of the polyvinylidene fluoride.
